(19) United States
(12) Patent Application Publication
(10) Pub. No.: US 2026/0088375 A1
(43) Pub. Date: Mar. 26, 2026

(54) DEVICES FOR PROVIDING CONSTANT PRESSURE ON BATTERY CELLS UNDER TEST AND ASSOCIATED SYSTEMS AND METHODS

(71) Applicant: Microvast, Inc., Stafford, TX (US)

(72) Inventors: Sangmin Lee, Stafford, TX (US); Noah Hopkins, Stafford, TX (US); Jason Beckman, Stafford, TX (US); Farnoud Jalalizadeh, Stafford, TX (US)

(21) Appl. No.: 18/895,009

(22) Filed: Sep. 24, 2024

(51) Int. Cl. H01M 10/42

(52) U.S. Cl. CPC H01M 10/4285; H01M 10/4207

(57) ABSTRACT

A battery cell testing system is provided. This system includes a platform and a force distributor disposed above the platform. The force distributor has a plate and a plurality of force distributor sheets disposed above the plate. The system also includes an arm disposed above the force distributor and a rod passing through and perpendicular to the arm, with the rod being in contact with the force distributor. In this system, a gravitational force of a weight is applied on one end of the arm such that the gravitational force of the weight results in a constant pressure on the plate, via the rod and the plurality of force distributor sheets. Additionally, the applied pressure on the plate is proportional to the gravitational force and a position on the arm through which the rod passes through.

### TECHNICAL FIELD

The present disclosure relates to battery cell testing and, in particular, to devices for providing constant pressure on battery cells during a mechanical test and associated systems and methods.

### BACKGROUND

Mechanical testing of battery cells, such as Li-ion battery cells, is a delicate procedure that involves the careful monitoring of changes in cell volume and pressure throughout the charge/discharge cycles. These cycles are critical periods when the battery cells undergo significant physical changes, commonly referred to as “swelling” and “breathing”. These terms describe the expansion and contraction, respectively, of the battery cell under test as the battery cells interact with the electrical energy being supplied to (or drawn from) it. One challenge with such testing arises from the fact that these physical changes are influenced by a myriad of variables, which can lead to a broadening of error margins in data analysis. When the error margin becomes too wide, the inherent variability in the testing conditions introduces a level of uncertainty that can render the data less reliable for practical applications.

To mitigate the issue of variable control, several testing methods have been developed that involve physically constraining a battery cell between two metal plates of a fixture. These plates are tightened to a specific torque setting using specialized hardware, with the intention of limiting the cell's displacement during the swelling and breathing phases. By doing so, researchers aim to isolate and measure the pressure exerted on the cell during the charge and discharge processes. In many testing applications, however, as the battery cell undergoes swelling, the fixture's constraints impact the battery cell volume, resulting in pressure fluctuations during charging and discharging. Moreover, since the volume constraint is not constant, the mechanical testing results include both displacement and pressure variations, adding another layer of difficulty to the analysis. Analyzing these combined results to characterize mechanical behavior and investigate the effect of mechanical constraints on the battery cell's electrochemical performance poses significant challenges due to the causality conjugate relationship between displacement and pressure (or stress).

### BRIEF DESCRIPTION OF THE DRAWINGS

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different embodiments designate like or corresponding, but not necessarily identical, elements.

FIG. 1 illustrates a leverage configuration that amplifies a constant gravitational force in accordance with various embodiments of the present technology.

FIG. 2 is a perspective view of a constant pressure maintenance system configured in accordance with various embodiments of the present technology.

FIG. 3. illustrates an interconnection of a linear rod and a force distributor of a constant pressure maintenance system in accordance with various embodiments of the present technology.

FIG. 4 shows a perspective view of a pin-to-pin point contact between a linear rod and a force distributor in accordance with various embodiments of the present technology.

FIG. 5 shows an exemplary force distribution sheet of a force distributor of a constant pressure maintenance system in accordance with various embodiments of the present technology.

FIG. 6 shows a calibration curve using load cell comparing weight applied to a constant pressure maintenance system in accordance with various embodiments of the present technology.

FIG. 7 shows applied force curves for battery cell mechanical testing in conventional metal plates fixture and a constant pressure maintenance system, respectively in accordance with various embodiments of the present technology.

FIG. 8 is a flow chart illustrating a method of applying a constant pressure on a battery cell under test in accordance with various embodiments of the present technology.

### DETAILED DESCRIPTION

The present disclosure relates to battery cell testing and, more specifically, to devices for providing constant pressure on battery cells during mechanical testing and associated systems and methods. As discussed previously, the mechanical characterization of energy storage devices, e.g., Li-ion battery cells, throughout cycling tests presents a complex interplay between displacement and pressure variations. As a battery cell under test undergoes charge and discharge cycles, both battery cell displacement (e.g., physical expansion and contraction of the cell) and internal pressure changes occur simultaneously. This causal relationship poses a significant challenge when attempting to correlate the battery cell's performance with external mechanical constraints, because it is difficult to isolate the effects of each of the variables. To overcome this challenge, an ideal approach would involve controlling either battery cell displacement or pressure applied thereon as a constant variable during the mechanical testing process. By maintaining one of these parameters at a steady state, it is possible to more accurately assess the impact of mechanical constraints on the battery cell's performance. This controlled setting would provide clearer insights into how external forces affect the battery's operational efficiency and longevity, enabling the development of more robust and reliable energy storage devices that can withstand varying mechanical stresses during their lifecycle.

Further, in the realm of testing battery cells under various mechanical conditions, the utilization of commercial electromechanical universal testing machines presents a significant challenge. These sophisticated commercial machines are designed to simulate a wide range of mechanical stresses on battery cells to ensure their durability and performance under different conditions. However, the practicality of employing such machines is limited by at least two main factors. First, the extensive time commitment required to conduct cycling tests on these machines can be prohibitive, as each test occupies the device for a considerable duration. This is particularly problematic when the testing apparatus is of high value and demand, leading to scheduling conflicts and reduced availability. Second, the volume of test cases necessary to thoroughly investigate the effects of diverse mechanical conditions further complicates the issue. The need to run a multitude of tests to cover the spectrum of potential scenarios means that the testing process can become exceedingly time-consuming and inefficient. Consequently, the use of these conventional electromechanical testing machines, while offering precise and controlled testing environments, may not be the most practical approach for extensive battery cell testing programs where numerous variables must be systematically explored.

To solve the issues and challenges described above, the present technology introduces a constant pressure maintenance device that is configured to provide constant pressure to the battery cell under test. The principle behind this constant pressure maintenance device is that gravitational force placed on the battery cell remains constant regardless of whether the battery cell is expanding or shrinking. To achieve constant gravitational pressure, a certain amount of weight can be placed above the battery cell. However, to address safety concerns related to heavy weight placements and minimizing fixture size, a principle of leverage is applied in the present technology. The gravitational weight (force) can be amplified through the leverage mechanism by the ratio of leverage arm lengths and maintains constant. In one specific example, for a battery cell with a surface area of 0.02 m² and a pressure requirement of 100 kPa, using direct weight would necessitate approximately 200 kg. In contrast, for a test utilizing a device configured in accordance with the present technology, a weight of 25 kg is only needed with a 1:8 leverage configuration. In addition, in some embodiments of the present technology, a four-bar linkage can be implemented to ensure that the force is aligned perpendicular to or generally perpendicular to the battery cell under test.

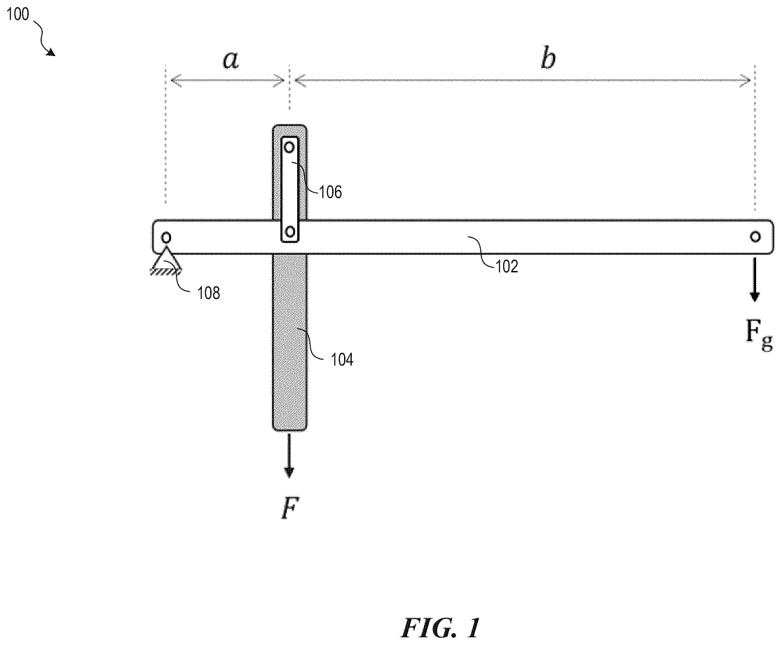

FIG. 1 illustrates a leverage configuration system 100 designed to amplify a constant gravitational force F_{g} by utilizing a lever arm 102 configuration in accordance with various embodiments of the present technology. In one specific embodiment, for example, when the ratio of the lever arm 102 is set such that a=1 and b=7, the resulting force F exerted is magnified to eight times the original gravitational force F_{g}. This is achieved through the mechanical advantage provided by the lever arm lengths a and b. In some other examples, the ratio of the lever arm 102 can range from 10 to 15. The system 100 incorporates a four bar-linkage to ensure that the amplified force F remains perpendicular to underneath testing sample, maintaining the directionality and efficiency of the force transfer. In this example, the components of the system 100 include the lever arm 102, and a rod 104 that is positioned perpendicular to the lever arm 102. A connection piece 106 serves to join the lever arm 102 and the rod 104, forming a rigid structure. Additionally, a support point 108 is present in the system 100, which acts as a pivot for one end of the lever arm 102. The opposite end of the lever arm 102 is where the constant gravitational force F_{g} is applied. As shown in FIG. 1, this design ensures that the amplified force F is not only proportional to the gravitational force F_{g} but also remains constant, providing a reliable and predictable output for the system's intended application. In general, the amplified force F can be calculated based on a formulation of

$$F = \frac{a + b}{a} Fg + {F}^{′} .$$

Here, the amplified force F can be also associated with additional gravitational force F′ that is caused by the weight of the rod 104 and the lever arm 102.

The present technology utilizes a novel method for maintaining constant external pressure during battery cell cycling tests without relying on expensive electromechanical testing machines. Specifically, this method is expected to enable a better understanding of how external constant pressure affects the battery performance by ensuring constant pressure conditions. In particular, this method involves measuring the displacement of the battery cell when an external force is applied and relating it to the stress and strain in the cell using Hooke's law for the continuous media. For example, Hooke's law for the continuous media describes the relationship between stress (σ) and stain (e) as:

$$σ = Ce$$

where C is the elasticity tensor. This equation can be simplified, and displacement of the battery cell (δ) can be computed when external force (F) is applied as:

$$δ = \frac{FL}{EA}$$

in which L is the cell thickness, E is the Young's modulus, and A denotes cell area, respectively.

The method of the present technology also accounts for the impact of the applied force on the electrochemical processes, such as the Li ion flux in the solid phase, which is governed by a coupled equation that involves the hydrostatic stress and the partial molar volume. For example, Li ion flux (J) in solid phase can be governed as

$$J = - {D}_{s} ( ∇ {c}_{s} - \frac{Ω {c}_{s}}{RT} ∇ {σ}_{h} )$$

where R is the gas constant and T is the temperature. In the equation, subscript s denotes solid phase and Dₛ and cₛ are solid phase diffusivity and Li-ion concentration, respectively. In this example, σₕ is the hydrostatic stress and computed from the stress as

$${σ}_{h} = \frac{{σ}_{11} + {σ}_{22} + {σ}_{33}}{3}$$

Ω is the partial molar volume which denotes volume change ratio of active particle when Li-ion intercalates or de-intercalates.

This electro-chemo-mechanical process is highly non-linear and makes decoupling of mechanical and electrochemical is very challenging. Throughout the charging and discharging process, a battery cell undergoes expansion or contraction, leading to variations in its thickness. When mechanical constraints are applied to limit this expansion, a reaction force can be generated, imposing pressure within the cell. Consequently, the measurement of cell pressure or displacement is due to combined both the mechanical constraints and the reactions produced. Characterizing mechanical properties such as elasticity tensor, C, using the mixed data becomes very challenging because there are more than two unknowns in an equation as:

$${σ}_{applied} + {σ}_{reaction} = C ( {e}_{response} + {e}_{reaction} )$$

However, this method, which maintains stress as a known constant, allows for characterizing the mechanical properties of the battery cell, such as the elasticity tensor, using the mixed data of cell pressure and displacement, by solving a system of equations described above.

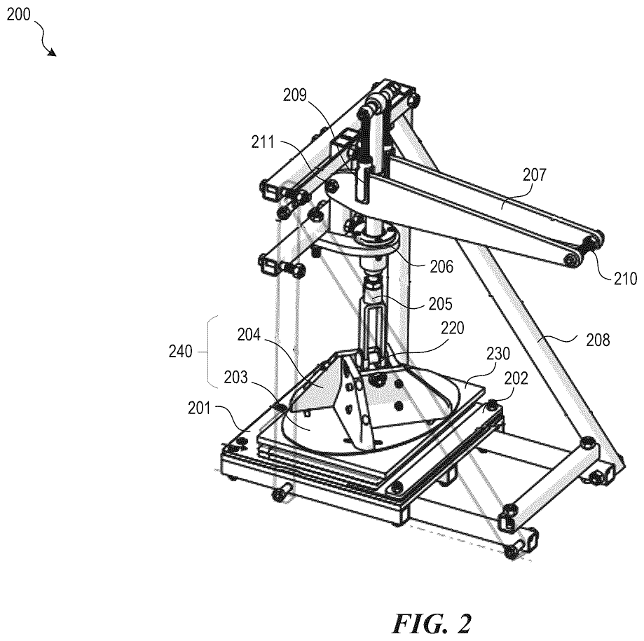

FIG. 2 is a perspective view of a battery testing system 200 configured in accordance with various embodiments of the present technology. In particular, the system 200 applies a constant pressure to a battery cell 230 during a test, e.g., charge and discharge cycles. As shown, the system 200 comprises a platform 201, a backstop guide 202, a plate 203, one or more force distribution sheets 204, a linear rod 205, a linear ball bearing 206, and lever arms 207. Those components of the system 200 are interconnected and secured by a frame 208, which denotes the remainder of the components that compose the entire body frame. In addition, the system 200 includes clevis rod ends 209 that interconnect the lever arms 207 and the linear rod 205.

In this example, the platform 201 is a base for supporting the battery cell 230 during testing. The platform 201 can be composed of, for example, phenolic linen, which is a non-conductive and heat-resistant material. In some other examples, the platform 201 can be made of plastic materials, glass, ceramic material, rubber, composite materials, or a combination thereof. As shown in FIG. 2, the backstop guide 202 can be a rectangular piece of phenolic linen that is attached to the platform 201 and serves as a reference for aligning the battery cell 230 in the center of the system 200. In this example, the system 200 includes a force distributor 240 comprising the force distribution sheets 204 and the plate 203. The plate 203 can be a flat piece of aluminum or another rigid material that is coated with non-conductive tape and has a size and thickness that match the weight and dimensions of the battery cell 230. In some other examples, the plate 203 can be made of materials comprising aluminum, steel, titanium, copper, magnesium, fiberglass, plastic, ceramics, composite materials, or a combination thereof. As shown in the embodiment illustrated in FIG. 2, the plate 203 is positioned to contact the top surface of the battery cell 230 and transfers the pressure from the lever arms 207 to the battery cell 230.

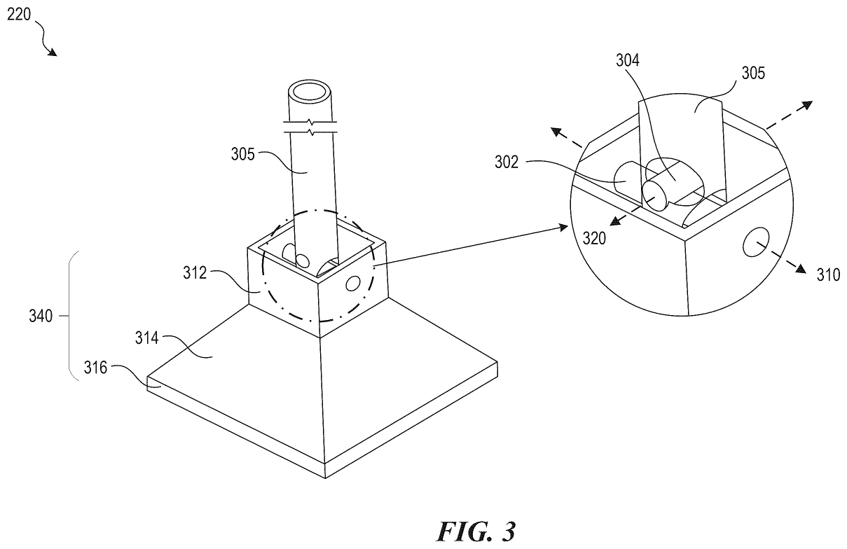

As shown in FIG. 2, the force distribution sheets 204 include multiple force distribution components that are secured to the plate 203 and extend perpendicularly or generally perpendicularly from the plate 203. The force distribution sheets 204 can be composed of, for example, acrylonitrile butadiene styrene (ABS), which is a plastic material that has high strength and durability. In this specific embodiment, the force distribution sheets 204 are positioned from a center to the four edge points of the plate 203. Those edge points are generally uniformly distributed at the edge of the plate 203, and therefore the force distributor 240 can be configured to distribute the pressure evenly (or with little variation) along the entire face of the battery cell 230. In this example, the system 200 also includes a pin-to-pin point contact 220 disposed between the linear rod 205 and the force distributor 240, which allows the plate 203 to move up and down freely, and to tilt along certain axes. In this specific embodiment, the plate 203 has a circular shape and each of the force distribution sheets 204 has a pentagon shape. In some other embodiments, the force distributor 240 can have various designs different to the one shown in FIG. 2. Specifically, the force distributor 240 as well as its plate 203 and force distribution sheets 204 can include different features and/or have different configurations. For example, the plate 203 can be in a rectangular or square shape, and each of the force distribution sheets 204 can be in a trapezoid shape. More detailed description regarding the force distributor 240 is provided in FIGS. 3-5 of this disclosure.

In the system 200 configured in accordance with the present technology, the linear rod 205 can be a long metal rod that passes through the center of the linear ball bearing 206 and that is connected to the force distributor 240 (e.g., the force distribution sheets 204) at the top and the lever arms 207 at the bottom. Here in this specific embodiment, the linear ball bearing 206 can be a cylindrical device that contains ball bearings and is operably fixed to the frame 208. Further, the linear ball bearing 206 is configured to enable the linear rod 205 to slide smoothly and with minimal friction along the vertical axis. In this example, the lever arms 207 can be two metal rods that are aligned in parallel. In addition, the lever arms 207 can be attached to the linear rod 205 and the frame 208 with clevis rod ends 209 and a bolt 211, respectively. As shown, the bolt 211 can pass through a first end portion of the lever arms 207 as a joint to interconnect the arms 207 and the frame 208. In the illustrated embodiment, the clevis rod ends 209 can be U-shaped connectors that allow the lever arms 207 to pivot and adjust to the movement of the linear rod 205. The lever arms 207 also have a bolt 210 disposed at a second end portion of the lever arms 207, which is used to hang a weight (not shown) that provides the force for applying pressure to the battery cell 230. As shown in FIG. 2, the first end portion is opposite to the second end portion on the lever arms 207. In other embodiments, however, the linear rod 205, linear ball bearing 206, lever arms 207, and/or clevis rod ends 209 can include different features and/or have different configurations.

In the present technology, the frame 208 can be a rectangular structure that is made of hollow steel tubing and supports the linear ball bearing 206 and the lever arms 207. The frame 208 also defines the height and width of the system 200 and can be modified accordingly to accommodate different sizes and weights of battery cells 230 to be tested. Specifically, the system 200 can be designed to have a force multiplication factor (e.g., a factor of eight), which means that the pressure applied to the battery cell 230 is eight times the weight hung on the bolts 210. However, the system 200 can be adapted to have different force multiplication factors by changing the length and angle of the lever arms 207 and the position of the linear rod 205 relative to the lever arms 207. In addition, the force applied on the battery cell 230 is also related to the weight of the force distributor 240 including the force distribution sheets 204 and the plate 203. In other embodiments, the frame 208 can include different features and/or have a different configuration.

In the present technology, the system 200 is configured to apply a constant force on the battery cell 230, through the linear rod 205 and the force distributor 240 underneath. Similar to the force amplification described in FIG. 1, the force or weight applied on the bolt 210 can be amplified and transferred to the plate 203 of the force distributor 240, which in turn compresses the battery cell 230. In this example, the force or weight applied on the bolt 210 is constant during the battery cell testing and can be upgraded based on the configuration of system 200. The linear rod 205 can be disposed along the vertical axis and aligned with the plate 203 at a right angle. Additionally, by tilting the plate 203 along various axes and vertically to form a firm contact between the plate 203 and a top surface of the battery cell 230, the amplified force can be uniformly (or with little variation) applied on the battery cell 230. Here, the firm contact can be made by contacting a whole frontside surface of the battery cell 230 with the plate 203. In another example, the firm contact can be formed by contacting a whole bottom surface of the plate 203 to the battery cell 230 under test. In other embodiments, the system 200 can include different features and/or different configurations to form contact between the force distributor 240 and the battery cell 230.

As described, the battery testing system 200 is expected to provide a cost-effective and versatile device for applying a constant pressure to the battery cell 230 under various conditions and measure the performance of the battery cell 230 during charge and discharge cycles. Specifically, the system 200 can include non-conductive and heat-resistant materials that are expected prevent electrical and thermal hazards and reduce friction and uneven pressure distribution to help ensure accurate and reliable results during operation. For example, in some embodiments, the system 200 is able to withstand temperatures up to 140 degrees Celsius without deformation.

FIG. 3 illustrates an enlarged view of a force distributor 340 and a linear rod 305 to illustrate the interconnection between the linear rod 205 and a force distributor 240 of FIG. 2 in accordance with various embodiments of the present technology. Here, the linear rod 305 and the force distributor 340 can perform similar functions to the rod 205 and force distributor 240 illustrated in FIG. 2. Particularly, in this specific embodiment, the force distributor 340 includes a plate 316 having a rectangular shape and four force distribution sheets 314. As shown, each of the force distribution sheets 314 has a trapezoid shape. In this example, the force distributor 340 also has a top portion 312 including four side walls. Each of the force distribution sheets 314 has a top edge connected to corresponding side wall bottom edge of the top portion 312 and a bottom edge connected to corresponding portions of the square plate 316. In this example, a top pin 304 passes through the bottom portion of the linear rod 305, and a bottom pin 302 passes through the top portion 312 of the force distributor 340. As shown, the side walls of the force distributor 340 are connected to the plate 203 via corresponding tilted force distributing sheets 314. In the illustrated embodiment, the bottom pin 302 pass through a pair of parallel aligned side walls of the top portion 312. In addition, the top pin 304 and the bottom pin 302 are perpendicular or generally perpendicular to each other, forming a right angle therebetween.

In the present technology, the linear rod 305 is not fixed to the force distributor 340. Instead, there is the pin-to-pin point contact formed between the top pin 304 and the bottom pin 302. During the operation of the system 200, the top pin 304 can be firmly disposed on the bottom pin 302 due to the amplified force applied on the lever arms 207, as well as gravitational forces caused by the mass of the linear rod 205. In this example, and as shown in the upper right zoomed in view of FIG. 3, the linear rod 305 has an open arc space disposed on its bottom end, enabling the linear rod 305 to tilt about a longitudinal axis 320 of the top pin 304. In addition, the force distributor 340 including the top portion 312, the force distribution sheets 314 and the plate 316, can be tilted about a longitudinal axis 310 of the bottom pin 302. This free tilting of linear rod 305 and force distributor 340 through the pin-to-pin point contact 220 is expected to keep the plate 316 in firm contact with the battery cell 230 under test (shown in FIG. 2).

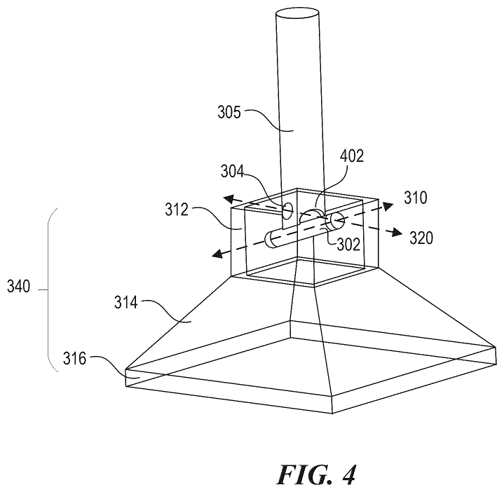

FIG. 4 is a partially transparent, perspective view of the pin-to-pin point contact 220 between the linear rod 305 and the force distributor 340 in accordance with various embodiments of the present technology. As shown, the bottom pin 302 is at least partially disposed in the open arc space of the bottom end of the linear rod 305 so that the linear rod 305 can be secured above the bottom pin 302. In this example, the open arc space of the linear rod 305 has an arc point 402 that is parallel to or higher than the low point surface of the top pin 304. During operation, this configuration is expected to ensure a firm pin-to-pin point contact between the top and bottom pins 304 and 302. In some other embodiments and when the system 200 is not in operation, the top pin 304 and the bottom pin 302 can be separated from each other.

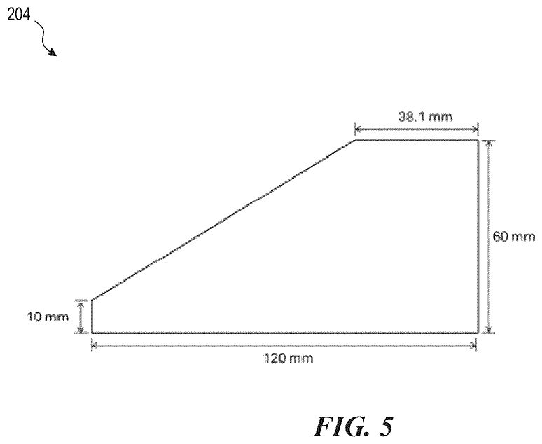

FIG. 5 shows a side view of an exemplary force distribution sheet 204 of the force distributor 240 of the system 200 of FIG. 2 in accordance with various embodiments of the present technology. In this example, the force distribution sheet 204 has a truncated pyramid shape, with a pair of horizontal lines aligned in parallel and a pair of vertical lines aligned in parallel. In addition, the force distribution sheet 204 includes a tilted line connecting the upper horizontal line and the lower vertical line. For example, the length of the pair of horizontal lines can range from 25.4 mm to 500 mm. In one specific embodiment, the upper horizontal line can be close to 38.1 mm and the bottom horizontal line can be close to 120 mm. Additionally, the length of the pair of vertical lines can range from 5 mm to 100 mm. In one specific embodiment, the taller vertical line can be close to 60 mm and the lower vertical line can be close to 10 mm. In this example, the bottom horizontal line can be disposed on the frontside surface of the plate 203. Moreover, a plurality of force distribution sheets 204 can be disposed above the plate 203 to ensure a uniformly distributed amplified force being transferred to the battery cell 230.

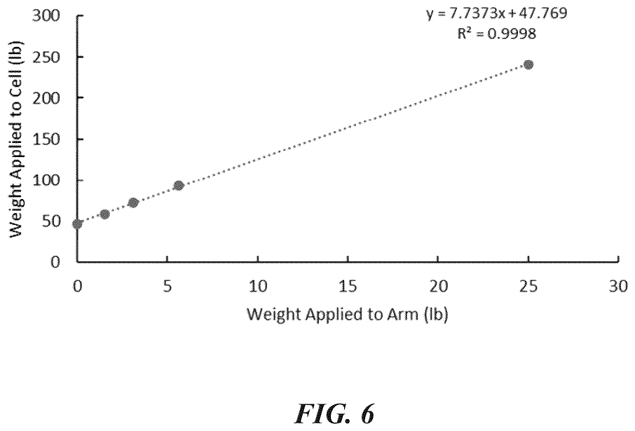

FIG. 6 illustrates a calibration curve obtained using a commercially available software (e.g., Loadstar LoadVUE® Pro (LV-1000) software) and a button load cell with a capacity of 1000 kg±0.5 kg. This curve compares the weight applied to the lever arms of a constant pressure maintenance system (e.g., the system 200 described in FIG. 2) with the force that is actually applied to the battery cell under test. This curve is useful for ensuring the accuracy of the constant pressure maintenance system by correlating the applied weight to the measured force, thereby validating the system's performance in maintaining a constant pressure.

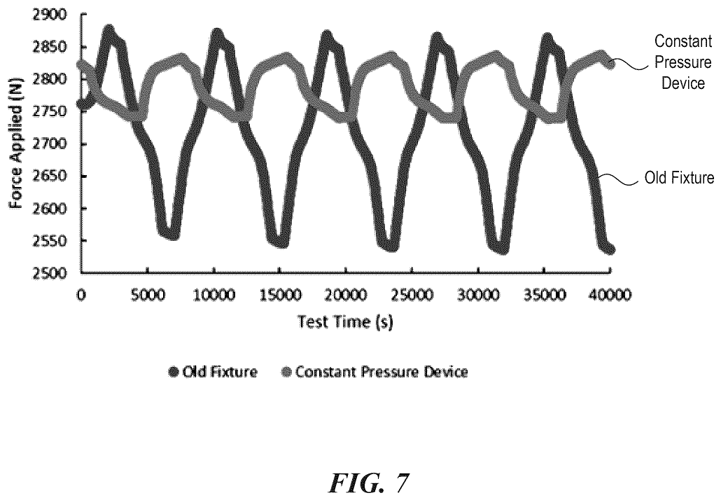

FIG. 7 presents the applied force curves obtained from mechanical testing of a Microvast 53.5Ah Li-ion pouch cell, comparing the performance of a conventional metal plates fixture with that of the constant pressure maintenance system. The testing was conducted at room temperature, cycling the cell at 1C1D using an Arvin 5V150A tester, and the force measurements were captured using the same Loadstar LoadVUE® Pro (LV-1000) software and a button load cell with a capacity of 1000 kg±0.5 kg. The curves demonstrate the effectiveness of the constant pressure maintenance system in comparison to the standard industry fixture, which typically consists of a cell sandwiched between two metal plates secured with bolts, washers, and nuts.

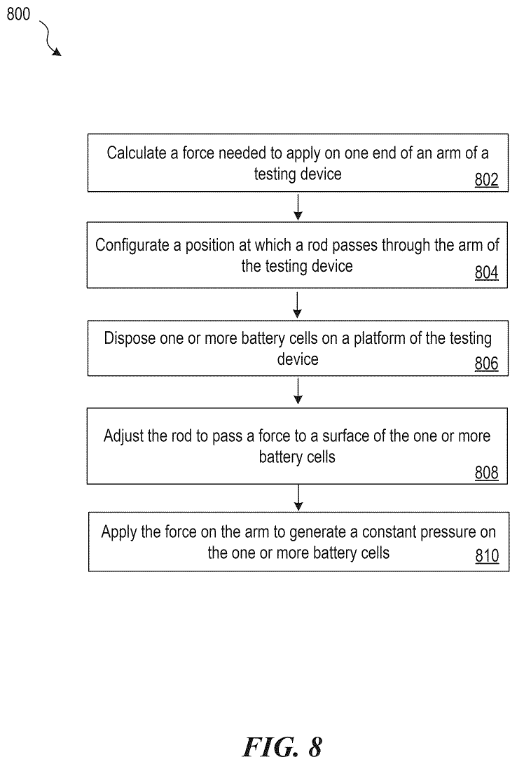

FIG. 8 is a flow chart illustrating a method 800 of applying a constant pressure on a battery cell under test in accordance with various embodiments of the present technology. Beginning at block 802, the method 800 includes calculating a force needed to apply on one end of an arm of a testing device. In one specific example, referring to FIGS. 1 and 2 together, a weight can be calculated based on needed gravity force on the bolt 210. The calculation may also consider the weight of the force distributor disposed above the battery cell 230.

At block 804, the method 800 includes configurating a position at which a rod passes through the arm of the testing device. In one specific example, referring to FIGS. 1 and 2 together, the linear rod 205 can be adjusted, horizontally along the longitudinal axis of the lever arms 207, to achieve a target force multiplication factor.

At block 806, the method 800 includes disposing one or more battery cells on a platform of the testing device. In one specific example and referring to FIGS. 1 and 2 together, the battery cell 230 can be disposed above the platform 201 and secured through adjusting the position of the backstop guide 202.

At block 808, the method 800 includes adjusting the rod to pass a force to a surface of the one or more battery cells. In one specific example and referring to FIGS. 1 to 4, the linear rod 205 can be adjusted, through the linear ball bearing 206 and along the vertical axis, to enable a firm contact between the top and bottom pins 304 and 302. This pin-to-pin point contact assists in forming the firm contact between the force distributor 240 and the battery cell 230.

Lastly, at block 810, the method 800 includes applying the force on the arm to generate a constant pressure on the one or more battery cells. In one specific example and referring to FIGS. 1 and 2 together, a weight can be applied on the bolt 210, generating an amplified force on the linear rod 205, which is further applied on the battery cell 230 through the force distributor disposed thereon.

In some embodiments, the method 800 also includes attaching a weight to one end of the arm of the testing device, and wherein the constant pressure is proportional to the resulting gravitational from the weight. For example, a weight (not shown) can be attached to the bolt 210 at one end of the lever arms 207, as illustrated in FIG. 2.

In some embodiments, the method 800 also includes adjusting the amount of weight attached to the arm based, at least in part, on a monitored pressure on the one or more battery cells. For example, referring again to FIG. 2, the amount of weight attached to the bolt 210 can be adjusted to form various forces F_{g}, corresponding to a difference between the monitored pressure on the battery cell 230 and a desired value.

In some embodiments, the method 800 also includes adjusting a plate of the force distributor such that the plate is in firm contact with the surface of the one or more battery cells under test, such that the rod is aligned, along its longitudinal axis, with the plate at a right angle. For example, with reference to FIGS. 2-4, the pin-to-pin point contact between the rod 205 and the force distributor 240 can be adjusted in order to form a firm contact between the plate 203 and the battery cell 230 under test.

Specific details of several embodiments of applying a constant pressure on a battery cell under test, and associated systems and methods, are described Above. A person skilled in the relevant art will recognize that suitable stages of the methods described herein can be performed at the battery level or at the system level. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

It should be emphasized that many variations and modifications can be made to the above-described examples, the elements of which are to be understood as being among other acceptable examples. All such modifications and variations are intended to be included herein within the scope of this disclosure and protected by the following claims. Various other aspects, features, and advantages of the disclosure will be apparent through the detailed description of the disclosure and the drawings attached hereto. It is also to be understood that both the foregoing general description and the following detailed description are examples and are not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

I/We claim:

1. A battery testing system, the system comprising:
a platform having a surface configured to receive a battery cell for testing;
an arm disposed above the platform, the arm having a first end portion and a second end portion opposite the first end portion;
a rod passing through the arm between the first end portion and the second end portion of the arm; and
a weight attached to the second end portion of the arm;
wherein the weight generates a force passing from the arm to the battery cell through the rod.

2. The system of claim 1, further comprising:
a force distributor disposed under the arm and the rod, wherein the force distributor is in contact with a lower end portion of the rod, wherein the force passes from the rod to the battery cell through the force distributor.

3. The system of claim 2, further comprising a frame, wherein the arm is attached through a joint at the first end portion of the arm.

4. The system of claim 3, further comprising a linear ball bearing attached to the frame and disposed between the arm and the force distributor, wherein the rod passes the linear ball bearing along a vertical direction.

5. The system of claim 1 wherein a ratio between a length of the first end portion of the arm and the second end portion of the arm ranges from 10 to 15.

6. The system of claim 1 wherein the rod is attached to the arm through clevis rod ends that are connected to an upper end portion of the rod.

7. The system of claim 1, further comprising a backstop guide disposed on the surface of the platform, wherein the backstop guide is configured to secure the battery cell on the platform.

8. The system of claim 2 wherein the force distributor comprises a plate and a plurality of force distribution sheets disposed above the plate, and wherein the plurality of force distribution sheets are configured to uniformly distribute applied force from the rod to the plate.

9. The system of claim 8 wherein the rod is aligned, along its longitudinal axis, with the plate at a right angle.

10. The system of claim 8 wherein the rod is aligned, along its longitudinal axis, with the plate at an angle less than 90 degrees.

11. The system of claim 2, further comprising a pin-to-pin point contact disposed between the lower end portion of the rod and the force distributor, wherein the pin-to-pin point contact comprises a top pin horizontally passing through the rod and a bottom pin secured to the force distributor, and wherein the top pin is perpendicular to the bottom pin.

12. The system of claim 11 wherein the lower end portion of the rod comprises an open space through which the bottom pin passes, and wherein the top pin and the bottom pin are in direct contact during operation.

13. The system of claim 11 wherein the rod is configured to adjust its position about a first axis extending along the top pin, and the force distributor is configured to rotate about a second axis extending along the bottom pin.

14. The system of claim 1 wherein the arm comprises two lever arms that are arranged in parallel and a bolt passing through the two lever arms at the second end portion of the arm, and wherein the weight is carried by the bolt.

15. A battery cell testing system, comprising:
a platform sized and shaped to receive a battery cell for testing;
an arm disposed above the platform; and
a rod passing through and in perpendicular to the arm,
wherein gravitational force from a weight is applied to one end portion of the arm, and wherein the gravitational force generates a constant pressure on the rod, and
wherein the generated pressure is proportional to the gravitational force and a position on the arm through which the rod passes.

16. A method of testing a battery, the method comprising:
calculating a force needed to apply on one end of an arm of a testing device;
configurating a position at which a rod passes through the arm of the testing device;
disposing one or more battery cells on a platform of the testing device;
adjusting the rod to pass the force to a surface of the one or more battery cells; and
applying the force on the arm to generate a constant pressure on the one or more battery cells.

17. The method of claim 16 wherein the force is applied through attaching a weight to end of the arm of the testing device, and wherein the constant pressure is proportional to a gravitational force of the weight.

18. The method of claim 17, further comprising adjusting the weight attached to the arm based, at least in part, on a monitored pressure on the one or more battery cells.

19. The method of claim 16, wherein the force is applied through a force distributor disposed above the one or more battery cells.

20. The method of claim 19, further comprising adjusting a plate of the force distributor such that the plate is in firm contact with the surface of the one or more battery cells under test, wherein the rod is aligned, along its longitudinal axis, with the plate at a right angle.
